(19) United States
(12) Patent Application Publication
(10) Pub. No.: US 2009/0060072 A1
(43) Pub. Date: Mar. 5, 2009

(54) DECODING METHOD FOR RECEIVING OFDM SIGNALS, AND DECODING APPARATUS AND RECEIVING APPARATUS USING THE SAME

(75) Inventor: Katsuaki HAMAMOTO, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/199,487

(22) Filed: Aug. 27, 2008

(30) Foreign Application Priority Data
Aug. 29, 2007 (JP) 2007-222879

(51) Int. Cl. H04L 27/28

(52) U.S. Cl. 375/260; 375/262; 375/340

(57) ABSTRACT

A phase derivation unit derives a phase difference between two symbols for each subcarrier, based on phase components of symbols. A weighting factor derivation unit derives a weighting factor for each subcarrier, based on amplitude components of the symbols. A multiplier weights the phase difference with the weighting factor for each subcarrier. A likelihood accumulation unit accumulates the weighted phase differences for a plurality of subcarriers. A decision units determines a result of accumulation. A substitution unit identifies a portion where known data are to be assigned, among the determined data frames, and substitutes the data in the identified portion with known data. A syndrome computation unit performs a syndrome computation on the data frames. An error detector detects an error in the data frames, based on a result of the syndrome computation.

### CROSS-REFERENCE TO RELATED APPLICATIONS

This application is based upon and claims the benefit of priority from the prior Japanese Patent Application No. 2007-222879, filed on Aug. 29, 2007, the entire contents of which are incorporated herein by reference.

### BACKGROUND OF THE INVENTION

1. Field of the Invention

The present invention relates to a decoding technique and, in particular, to a decoding method for receiving OFDM signals and a decoding apparatus and a receiving apparatus using the same.

2. Description of the Related Art

The OFDM (Orthogonal Frequency Division Multiplexing) modulation is one of digital signal transmission schemes. In the OFDM modulation scheme, a plurality of subcarriers are used and data on a frequency axis assigned to their respective subcarriers are converted into data on a time axis by IFFT (Inverse Fast Fourier Transform) before they are transmitted. The OFDM technique like this is applied to digital terrestrial television broadcasting, such as DVB-T (Digital Video Broadcasting—Terrestrial) and ISDB-T (Integrated Services Digital Broadcasting—Terrestrial).

In digital terrestrial television broadcasting, control signals are assigned to some of the plurality of subcarriers. These control signals, which contain information necessary for receiving data signals, are more important than the data signals. Accordingly, the control signals are so designed as to reduce errors. As control signals, DVB-T includes TPS (Transmission Parameter Signaling), whereas ISDB-T includes TMCC (Transmission and Multiplexing Configuration Control). TPS and TMCC are of different formats from each other, but have certain common features as the design for reducing errors. One of them is the use of DBPSK (Differential Binary Phase Shift Keying) as the modulation scheme, and another is the use of BCH (Bose-Chaudhuri-Hocquenghem) codes as the error detection/correction method. Under these circumstances, it is desired that the receiving characteristics for receiving OFDM signals be improved while suppressing the increase in circuit size of a receiving apparatus.

### SUMMARY OF THE INVENTION

The inventor has made the present invention in recognition of the foregoing circumstances, and a general purpose of the invention is to provide a communication technology that improves receiving characteristics while reducing the increase in circuit size of a receiving apparatus.

In order to resolve the above problems, a decoding apparatus according to one embodiment of the present invention comprises: an input unit which inputs a block-coded data frame; a substitution unit which specifies an area, where known data are to be assigned, among the data frame inputted in said input unit and which substitutes data in the specified area with the known data; a computing unit which performs syndrome computation on the data frame substituted by the substitution unit; and a detector which detects an error in the data frame, based on a result of syndrome computation performed by the computing unit.

Another embodiment of the present invention relates to a receiving apparatus. This apparatus comprises: a receiver which receives a multicarrier signal where control signals are assigned to at least two subcarriers and data signals are assigned to the remaining subcarriers; a separator which separates the multicarrier signal received by the receiver into the control signals and the data signals; a first demodulator which demodulates the control signals separated by the separator; and a second demodulator which demodulates the data signals separated by the separator. The first demodulator includes: a substitution unit which specifies an area, where known data are to be assigned, among a block-coded data frame and which substitutes data in the specified area with the known data, the data frame being data frame of the control signals separated by said separator; a computing unit which performs syndrome computation on the data frame substituted by the substitution unit; and a detector which detects an error in the data frame, based on a result of syndrome computation performed by the computing unit.

Still another embodiment of the present invention relates to a decoding method. This method comprises: inputting a block-coded data frame; specifying an area, where known data are to be assigned, among the inputted data frame and substituting data in the specified area with the known data; performing syndrome computation on the substituted data frame; and detecting an error in the data frame, based on a result of syndrome computation.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 shows a structure of a receiving apparatus according to an exemplary embodiment of the present invention;

FIG. 2 shows an arrangement of OFDM symbols to be processed by the receiving apparatus of FIG. 1;

FIGS. 3A and 3B show a frame format of TPS to be processed by the receiving apparatus of FIG. 1;

FIG. 4 shows values of TPS to be processed by the receiving apparatus of FIG. 1;

FIG. 5 shows a structure of a control signal processor of FIG. 1;

FIG. 6 shows the likelihoods of phase difference derived by a phase difference derivation unit of FIG. 5;

FIG. 7 shows a structure of a storage of FIG. 5;

FIG. 8 shows a structure of a likelihood derivation unit according to a modification of the exemplary embodiment of the present invention;

FIG. 9 shows a structure of a setting unit of FIG. 8;

FIG. 10 shows a structure of a storage according to another modification of an exemplary embodiment of the present invention; and

FIG. 11 shows a frame format of TMCC according to still another modification of an exemplary embodiment of the present invention.

### DETAILED DESCRIPTION OF THE INVENTION

The invention will now be described by reference to the preferred embodiments. This does not intend to limit the scope of the present invention, but to exemplify the invention.

The present invention will be outlined hereinbelow before it is described in detail. Exemplary embodiments of the present invention relate to a receiving apparatus for receiving radio signals of digital terrestrial television broadcasting such as DVB-T. Such a radio signal is constituted by a series of OFDM symbols. In DVB-T, TPS is assigned to some of a plurality of subcarriers. As mentioned already, DBPSK and BCH are employed to reduce the error occurrence probability in TPS. To demodulate a DBPSK signal, a differential detection is normally carried out at the receiving apparatus. It is known that if the phase component only is used in differential detection, then the receiving characteristics deteriorate markedly in a fading environment. On the other hand, if vector operation is performed in differential detection, complex multiplication will become necessary, which will result in an increase in circuit size. Hence, it is required that the increase in circuit size and the degradation of receiving characteristics on account of differential detection be prevented. If errors beyond the detection capacity of BCH occur, the errors will not be detected and thus no corrections will take place. Therefore it is also desired that some processing be done to reduce errors before they are detected.

First, processing as described below is performed to prevent the increase in circuit size and the degradation of receiving characteristics in differential detection. The receiving apparatus extracts subcarriers to which TPS is assigned (hereinafter referred to as “TPS subcarriers”) out of a plurality of subcarriers, and then converts the symbols of the TPS subcarriers into the phase components and the amplitude components thereof. Also, the receiving apparatus derives a likelihood of phase difference of a DBPSK modulation signal by calculating a phase difference between successive symbols in each TPS subcarrier. At the same time, the receiving apparatus derives a weighting factor of phase difference likelihood from the amplitude components of the successive symbols. Further, the receiving apparatus accumulates the likelihoods of the DBPSK modulation signal, which are the product of multiplying the phase difference likelihoods by the weighting factor, over the plurality of TPS subcarriers contained in a singe symbol. The accumulated value is then determined, and the result of the demodulation of the DBPSK modulation signal is generated.

Next, processing as described below is performed to reduce errors before detection. It is assumed here that a TPS is constituted by a frame, and a frame synchronization code is assigned in the frame. Note that the frame synchronization code is a signal used in frame synchronization, which is a known signal. The receiving apparatus specifies a portion where the frame synchronization code is to be assigned in a demodulated frame. Also, the receiving apparatus, which stores the pattern of the frame synchronization code in advance, substitutes the frame synchronization code for the specified portion. Then the receiving apparatus carries out error detection and error correction.

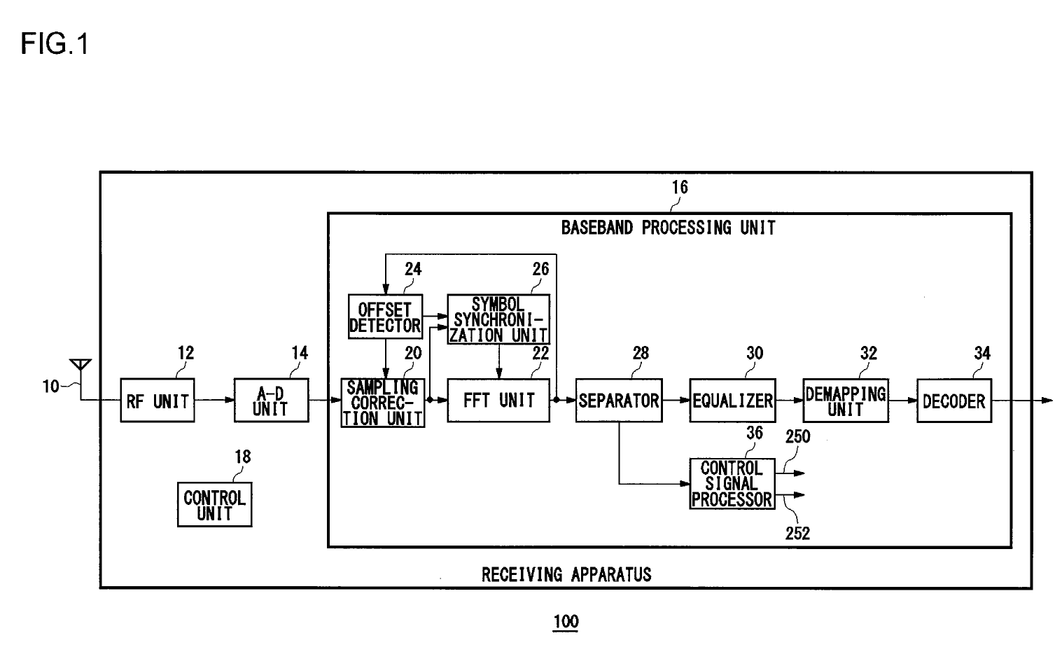

FIG. 1 shows a structure of a receiving apparatus 100 according to an exemplary embodiment of the present invention. The receiving apparatus 100 includes an antenna 10, an RF unit 12, an A-D unit 14, a baseband processing unit 16, and a control unit 18. The baseband processing unit 16 includes a sampling correction unit 20, an FFT unit 22, an offset detector 24, a symbol synchronization unit 26, a separator 28, an equalizer 30, a demapping unit 32, a decoder 34, and a control signal processor 36. Included as signals are TPS 250 and error flag 252.

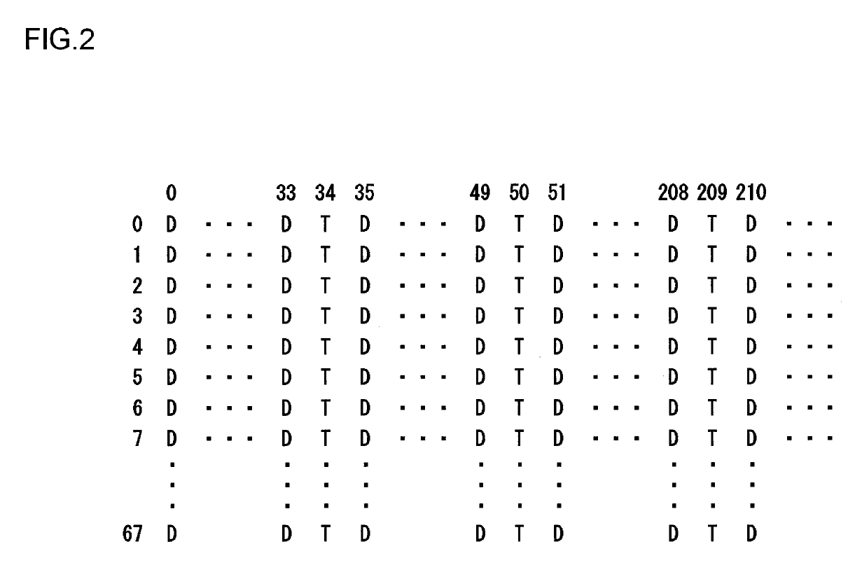

The antenna 10 receives a radio signal from a not-shown transmitting apparatus. The radio signal here belongs to a radio frequency band and is composed of a repetition of aforementioned OFDM symbols. FIG. 2 shows an arrangement of OFDM symbols to be processed by the receiving apparatus 100. The rows of FIG. 2 correspond to frequency, and the numbers shown in the topmost row are subcarrier numbers. And the columns of FIG. 2 correspond to time, and the numbers shown in the leftmost column are symbol numbers. “D” in FIG. 2 represents data, whereas “T” represents TPS. Of the OFDM symbols, therefore, TPS is assigned to some of the subcarriers, and data are assigned to the rest of the subcarriers. Note here that a 2 k mode and an 8 k mode are defined for DVB-T. The 2 k mode corresponds to a case where the number of IFFT points is 2048 samples, whereas the 8 k mode corresponds to a case where the number of IFFT points is 8192 samples. In the 2 k mode there are 17 TPS subcarriers, and in the 8 k mode there are 68 TPS subcarriers.

Since 1 bit of TPS information is transmitted by a single OFDM symbol, the same TPS information is assigned to each TPS subcarrier. Hence, in the 2 k mode the same TPS data are assigned to 17 subcarriers, and in the 8 k mode the same TPS data are assigned to 68 subcarriers before they are transmitted. At this point, the same TPS information assigned to each TPS subcarrier is differentially-coded by the data of each TPS subcarrier of an immediately preceding OFDM symbol.

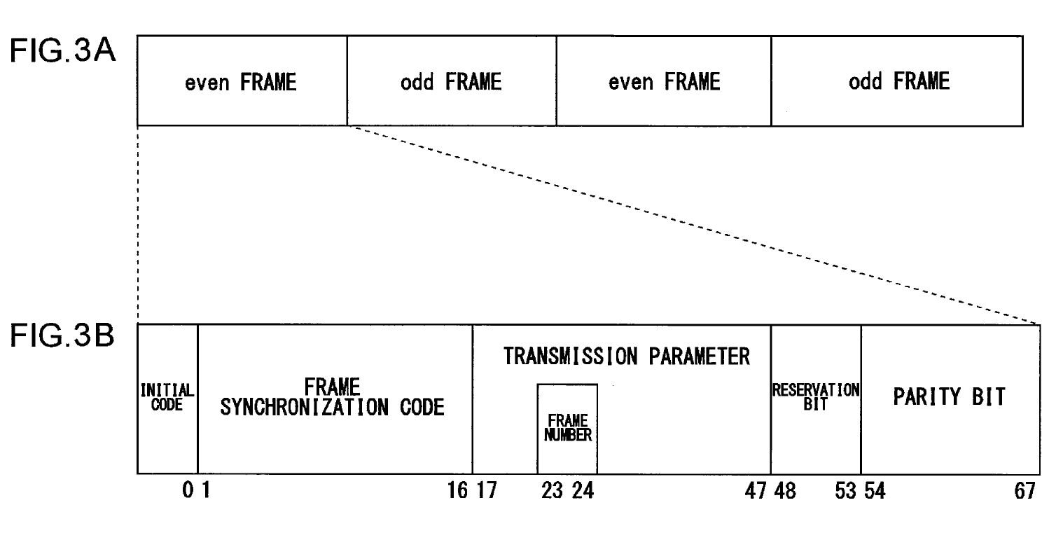

FIGS. 3A and 3B show a frame format of TPS to be processed by the receiving apparatus 100. As already described, TPS is defined in a frame format. FIG. 3A shows an alternate placement of “even frame” and “odd frame” (“even frame” and “odd frame” hereinafter referred to collectively as “TPS frame”). FIG. 3B shows a constitution of a single TPS frame. As shown in FIG. 3B, a TPS frame is comprised of 68 bits. Since 1 bit of TPS information is transmitted by a single OFDM symbol as shown in FIG. 2, a transmission of a single TPS frame, which is comprised of 68 bits, is completed by 68 symbols.

An “initial code” is a start symbol for performing a differential coding of a TPS frame. The value of an initial code is so defined as to be dependent on the subcarrier number of the TPS subcarrier. A “frame synchronization code” is a stream of known signals used to establish synchronization of a TPS frame. Note that an “even code” of “0011010111101110” and an “odd code” of “1100101000010001” are defined as frame synchronization codes. And note also that the even code is placed in an even frame, and the odd code is placed in an odd frame.

In a “transmission parameter”, items of information, such as modulation scheme, coding rate, and guard interval length, are mapped. Also included in the transmission parameter is a frame number. The frame number is so defined that the values of 0 to 3 are repeated. “Reservation bits” are bits reserved in advance. “Parity bits” are codes for carrying out error detections and corrections on symbols 0 to 53 by BCH decoding. The description of the parity bits is omitted here because they can be generated by a known technique.

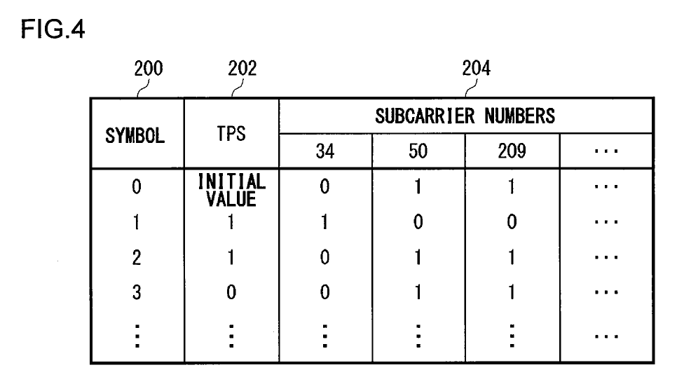

FIG. 4 shows the values of TPS to be processed by the receiving apparatus 100. Here a description will be given specifically of the values which may result from a differential coding of the values of a TPS frame as shown in FIG. 3B. The symbol numbers shown in a symbol column 200 correspond to the numbers shown on the left in FIG. 2 and the numbers shown in the bottommost row of FIG. 3B. Shown in the TPS column 202 are the specific values of the TPS frame shown in FIG. 3B. Note that as the initial values, random data dependent on the subcarrier number is mapped as mentioned above. The subcarrier number column 204 shows the values of a differentially-coded TPS frame associated with different TPS subcarriers. As shown in FIG. 4, the initial values “0”, “1”, and “1” are assigned to the subcarrier numbers “34”, “50”, and “209”, respectively. Also, DBPSK modulation is performed on the subsequent part of the TPS frame based on the initial value. To be more specific, when the value of TPS frame is “1”, the preceding value is inverted, and when it is “0”, the preceding value is not inverted. Refer back now to FIG. 1.

The RF unit 12 performs a frequency conversion from a radiofrequency band to a baseband on OFDM symbols received successively by the antenna 10. The RF unit 12 also outputs the OFDM symbols having been frequency-converted to the baseband. The baseband signal, which is composed of in-phase components and quadrature components, shall generally be transmitted by two signal lines. For the clarity of Figures, the baseband signal is presented here by a single signal line only. The RF unit 12 also has the tuner function and the amplifier function, but the description thereof is omitted here. The A-D unit 14 performs an analog-to-digital conversion on the baseband OFDM symbols. As a result, the A-D unit 14 outputs OFDM symbols converted into digital signals. Hereinbelow, however, the OFDM symbols having been converted into digital signals are also called simply “OFDM symbols”.

The sampling correction unit 20 receives OFDM symbols from the A-D unit 14 and corrects the sampling timing at the A-D unit 14. Note that the amount of correction for the sampling timing is indicated by the offset detector 24. The FFT unit 22 removes guard intervals from OFDM symbols. The FFT unit 22 also performs Fourier transform on the OFDM symbols with the guard intervals removed and outputs signals converted into the frequency domain. As a result, signals separated in subcarrier units as shown in FIG. 2 are outputted.

The offset detector 24 detects the offset of timing based on the signals converted into the frequency domain. Also, the offset detector 24 reports the detected offset to the symbol synchronization unit 26. Further, the offset detector 24 derives the amount of correction for the sampling timing based on the offset and reports it to the sampling correction unit 20. The symbol synchronization unit 26 generates an FFT window based on the OFDM symbol from the sampling correction unit 20 and the offset from the offset detector 24 and outputs it to the FFT unit 22. It is to be noted that detailed description of the sampling correction unit 20, the FFT unit 22, the offset detector 24, and the symbol synchronization unit 26 is omitted here because known art can be applied to them.

The separator 28 receives the input of signals converted into the frequency domain from the FFT unit 22 and separates them into TPS subcarriers and the other subcarriers. The separator 28 also outputs the TPS subcarriers to the control signal processor 36 and outputs the other subcarriers to the equalizer 30. The equalizer 30 estimates channel characteristics based on the signals in the frequency domain from the separator 28. At this point, the channel characteristics are derived subcarrier by subcarrier. It is to be noted that a description of the estimation of channel characteristics is omitted here because known art can be applied to it. Note, however, that pilot signals assigned to predetermined subcarriers are used in the estimation of channel characteristics. The equalizer 30 demodulates the signals in the frequency domain based on the estimated channel characteristics. The demodulation is also done on a subcarrier-by-subcarrier basis.

The demapping unit 32 performs a demapping on the signals demodulated by the equalizer 30. The decoder 34 decodes the results of demapping at the demapping unit 32. The control signal processor 36 receives TPS subcarriers from the separator 28 and carries out demodulation and decoding on the TPS frames. The demodulation and decoding here will be explained later. The control signal processor 36 outputs TPS 250 and error flags 252. The control unit 18 controls the timing of the receiving apparatus 100.

This structure may be implemented hardwarewise by elements such as a CPU, memory and other LSIs of an arbitrary computer, and softwarewise by memory-loaded programs having receiving functions or the like. Depicted herein are functional blocks implemented by cooperation of hardware and software. Therefore, it will be obvious to those skilled in the art that the functional blocks may be implemented by a variety of manners including hardware only, software only or a combination of both.

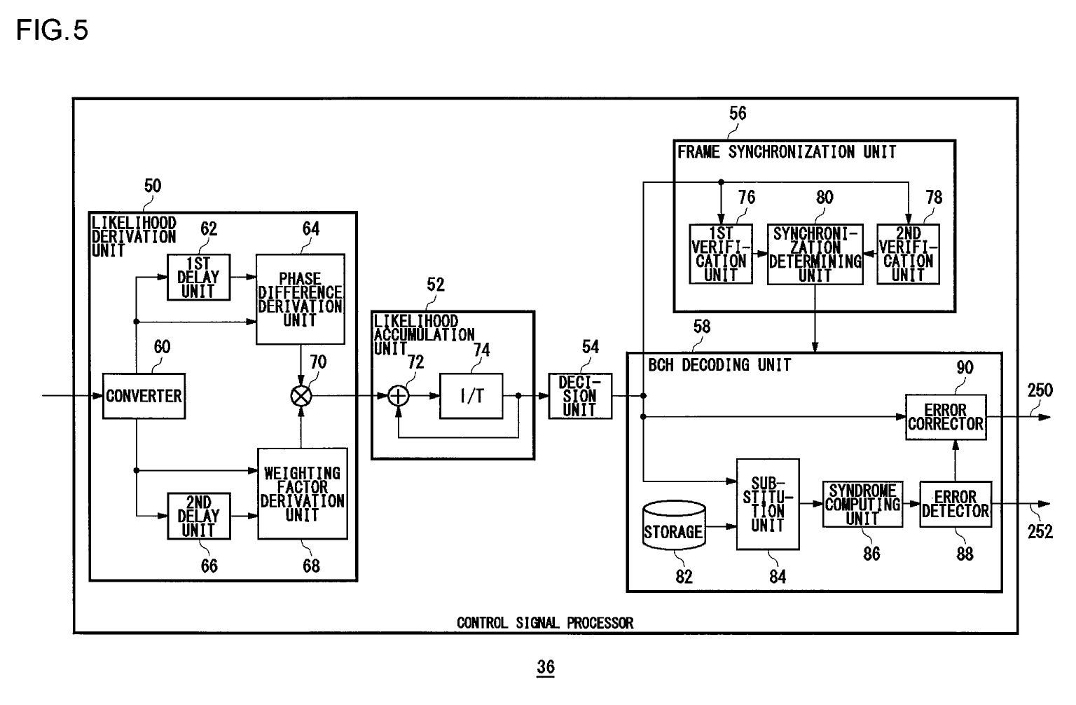

FIG. 5 shows a structure of the control signal processor 36. The control signal processor 36 includes a likelihood derivation unit 50, a likelihood accumulation unit 52, a decision unit 54, a frame synchronization unit 56, and a BCH decoding unit 58. The likelihood derivation unit 50 includes a converter 60, a first delay unit 62, a phase difference derivation unit 64, a second delay unit 66, a weighting factor derivation unit 68, and a multiplier 70. The likelihood accumulation unit 52 includes an adder 72 and an adjuster 74. The frame synchronization unit 56 includes a first verification unit 76, a second verification unit 78, and a synchronization determination unit 80. And the BCH decoding unit 58 includes a storage 82, a substitution unit 84, a syndrome computation unit 86, and error detector 88, and an error corrector 90.

Symbols assigned to TPS subcarriers are inputted to the converter 60. Assigned to the TPS subcarriers are TPS frames which are the data of the same content among the subcarriers having been differentially-coded. Here, the symbols inputted to the converter 60, which are composed of in-phase components and quadrature components, are converted into amplitude components and phase components. Now the converter 60, which is provided with a not-shown arctangent ROM, carries out the conversion, using the arctangent ROM. Note that the conversion is performed subcarrier by subcarrier. The converter 60 outputs the phase components of the symbols to the first delay unit 62 and the phase difference derivation unit 64 and outputs the amplitude components of the symbols to the second delay unit 66 and the weighting factor derivation unit 68.

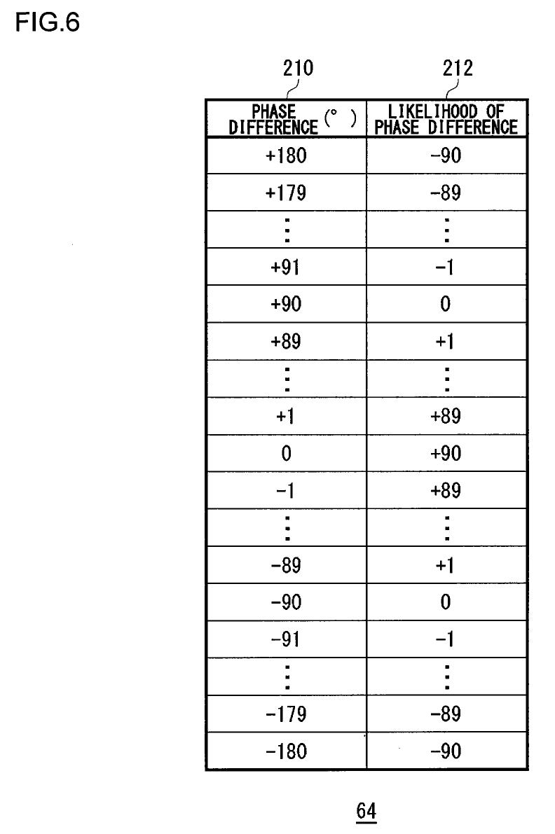

The first delay unit 62 delays the phase component of a symbol by a portion corresponding to one symbol. The phase difference derivation unit 64 receives the phase component of a symbol from the converter 60 and at the same time receives the phase component of a symbol from the first delay unit 62. The phase difference derivation unit 64 derives the phase difference between the two symbols based on the inputted phase components of the symbols subcarrier by subcarrier. Also, the phase difference derivation unit 64 outputs the phase difference as a likelihood of phase difference. FIG. 6 shows the likelihoods of phase difference derived by the phase difference derivation unit 64. Shown in a phase difference column 210 are phase differences between two symbols, and shown in a phase difference likelihood column 212 are the likelihoods of phase difference corresponding to the phase differences.

For example, if the phase difference is “0 degrees”, the likelihood of phase difference will be “+90”, and if the phase difference is “+180 degrees” or “−180 degrees”, then the likelihood of phase difference will be “−90”. Here, since the modulation scheme for TPS is DBPSK, the phase difference should ideally be “0 degrees” or “±180 degrees”. Also, it can be said that the closer the phase difference approaches these values, the greater the reliability of the scheme will be. Accordingly, the specification is such that as the phase difference approaches “0 degrees” or “±180 degrees”, the likelihood of phase difference takes a greater absolute value. Refer back now to FIG. 5. The phase difference derivation unit 64 outputs phase difference likelihoods to the multiplier 70.

The second delay unit 66 delays the amplitude component of a symbol by a portion corresponding to one symbol. The weighting factor derivation unit 68 receives the amplitude component of a symbol from the converter 60 and at the same time receives the amplitude component of a symbol from the first delay unit 62. The weighting factor derivation unit 68 derives a weighting factor based on the inputted amplitude components of the symbols on a subcarrier by subcarrier basis. That is, the weighting factor derivation unit 68 identifies two amplitude components for the two symbols respectively used in the derivation of phase difference at the phase difference derivation unit 64. The weighting factor derivation unit 68 selects the smaller of the two amplitude components. The weighting factor derivation unit 68 generates a weighting factor for a phase difference based on the selected amplitude component. For example, the weighting factor derivation unit 68 generates a weighting factor which takes a larger value for a larger amplitude component. Here, for the clarity of explanation, the weighting factor derivation unit 68 uses the value of amplitude component as the weighting factor.

The multiplier 70 multiplies a phase difference likelihood from the phase difference derivation unit 64 and a weighting factor from the weighting factor derivation unit 68 together in association with the subcarrier. That is, the multiplier 70 weights the phase difference likelihood by the weighting factor on subcarrier by subcarrier basis. The adder 72 and the adjuster 74 accumulate the weighted phase difference likelihoods for a plurality of TPS subcarriers. The decision unit 54 makes a decision on the result of the accumulation. The result of the decision, if there is no error in it, will be a state of a TPS frame minus the initial code. Note that such a state is called a TPS frame also.

The first verification unit 76 receives a decision result from the decision unit 54. The first verification unit 76 also stores the pattern of an even code in advance. Note that an even code is composed of 16 bits. The first verification unit 76, which has a matched filter constitution, calculates a correlation value of the 16 bits of decision result and the 16 bits of the even code. For instance, the first verification unit 76 executes XOR for each bit and totals the appearance counts of “0” in each digit. The first verification unit 76 outputs the result of the totaling to the synchronization determination unit 80. The second verification unit 78 carries out the same operation as the first verification unit 76 on the odd code.

The synchronization determination unit 80 receives the results of verification from the first verification unit 76 and the second verification unit 78. Since the even frames and the odd frames are transmitted alternately as shown in FIG. 3A, the synchronization determination unit 80 determines a synchronization timing by repeating the verification until either of the two verification results shows “16”. As a result, a frame synchronization is established. The synchronization determination unit 80 outputs the determined synchronization timing and information on which of the even code and the odd code has been used in establishing the synchronization timing, to the BCH decoder 58 and the not-shown control unit 18.

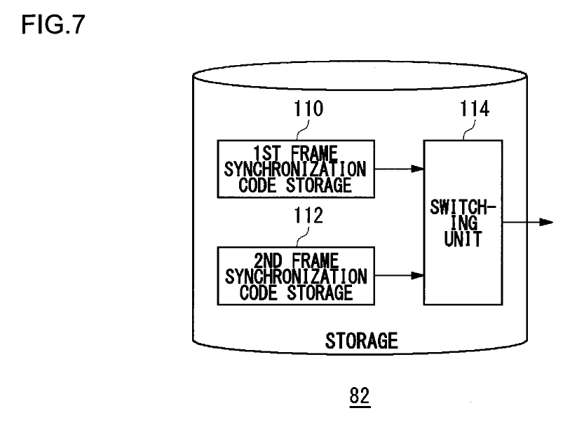

The storage 82 stores even codes and odd codes. For an even frame, the storage 82 outputs an even code, and for an odd frame, it outputs an odd code. In other words, the storage 82 outputs “0011010111101110” bit by bit successively for each symbol or “1100101000010001” bit by bit successively for each symbol. Note that which of an even frame and an odd frame and the timing for outputting a frame synchronization code are indicated by the not-shown control unit 18. FIG. 7 shows a structure of the storage 82. The storage 82 includes a first frame synchronization code storage 110, a second frame synchronization code storage 112, and a switching unit 114. The first frame synchronization code storage 110 stores even codes. The second frame synchronization code storage 112 stores odd codes. Following an instruction from the not-shown control unit 18, the switching unit 114 selects an even code or an odd code and outputs it. Refer back now to FIG. 5.

The substitution unit 84 receives the input of a decision result from the decision unit 54. The decision result, which is in a format as shown in FIG. 3B, corresponds to a BCH-coded TPS frame. Note, however, that there are possibilities of the decision result containing some error and hence there are cases where it may not completely agree with FIG. 3B. For the simplicity of explanation, however, the decision result is called a TPS frame here. As already mentioned, the TPS frame contains a frame synchronization code to be used for establishing a frame synchronization. The substitution unit 84 identifies a portion of an inputted TPS frame where a frame synchronization code is to be placed, and substitutes an even code or an odd code for the data in the identified portion. Here the substitution unit 84, which has acquired an even code or an odd code from the storage 82, uses for the substitution the even code for an even frame or the odd code for an odd frame. It is to be noted that the substitution unit 84 outputs the decision result inputted from the decision unit 54 as it is in the parts other than the portion where the frame synchronization code is placed. Note also that the TPS frame after the substitution with the frame synchronization code is herein called a TPS frame as well.

The syndrome computation unit 86 receives a TPS frame from the substitution unit 84 and performs a syndrome computation on the TPS frame. The error detector 88 detects an error, if any, in the TPS frame based on the result of syndrome computation by the syndrome computation unit 86. That is, an error position is identified. Also, the error detector outputs an error flag 252. The error corrector 90 receives a decision result from the decision unit 54 and at the same time receives the input of information on the error position from the error detector 88 and carries out an error correction. The error corrector 90 outputs the result of the error correction as TPS 250. Description of the syndrome computation, error detection and error correction is omitted here because known art can be applied to them.

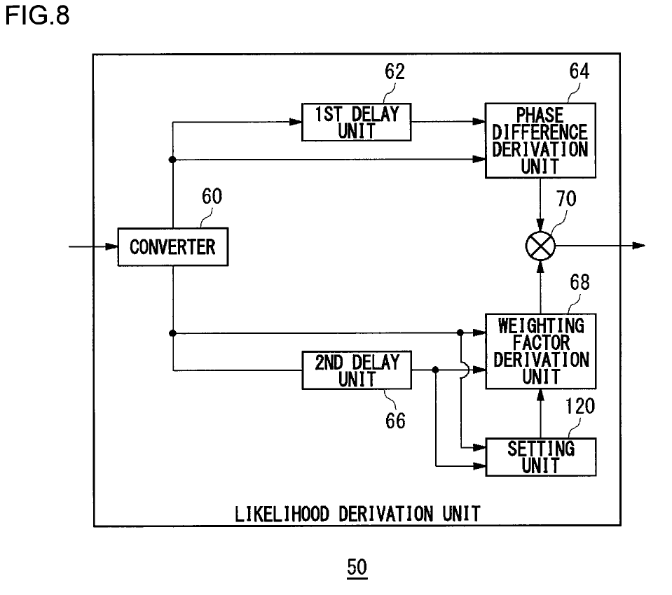

Now a description will be given of a modification of the exemplary embodiment of the present invention. The modification utilizes a weighting factor derivation method at the likelihood derivation unit 50 different from that of the exemplary embodiment. A receiving apparatus 100 according to this modification is of the same type as one shown in FIG. 1. FIG. 8 shows a structure of a likelihood derivation unit 50 according to the modification of the exemplary embodiment. The likelihood derivation unit 50 further includes a setting unit 120 in addition to the structural components of the likelihood derivation unit 50 of FIG. 5. The setting unit 120 sets a threshold value which is to be used by the weighting factor derivation unit 68. The setting unit 120 may store a fixed threshold value in advance or may set a threshold value adaptively according to the channel condition.

For example, the setting unit 120 selects the larger of the amplitude component of a preceding symbol and that of a present symbol for each TPS subcarrier and accumulates the selected values for the plurality of TPS subcarriers. On the other hand, the setting unit 120 obtains the absolute value of the difference between the amplitude component of the preceding symbol and that of the present symbol for each TPS subcarrier and accumulates the absolute values for the plurality of TPS subcarriers. Also, the setting unit 120 normalizes the accumulation result of differences based on the accumulation of the selected values and the differences. Further, the setting unit 120 determines a threshold value from the result of the normalization.

The weighting factor derivation unit 68 selects the smaller of two amplitude components in the same manner as in the exemplary embodiment. When the selected amplitude component is smaller than the threshold value, however, the weighting factor derivation unit 68 generates such a weighting factor as to nullify the phase difference. For instance, the weighting factor derivation unit 68 sets “0” for the value of weighting factor. Other processes at the likelihood derivation unit 50 are the same as those in the exemplary embodiment, and therefore the description thereof is omitted here.

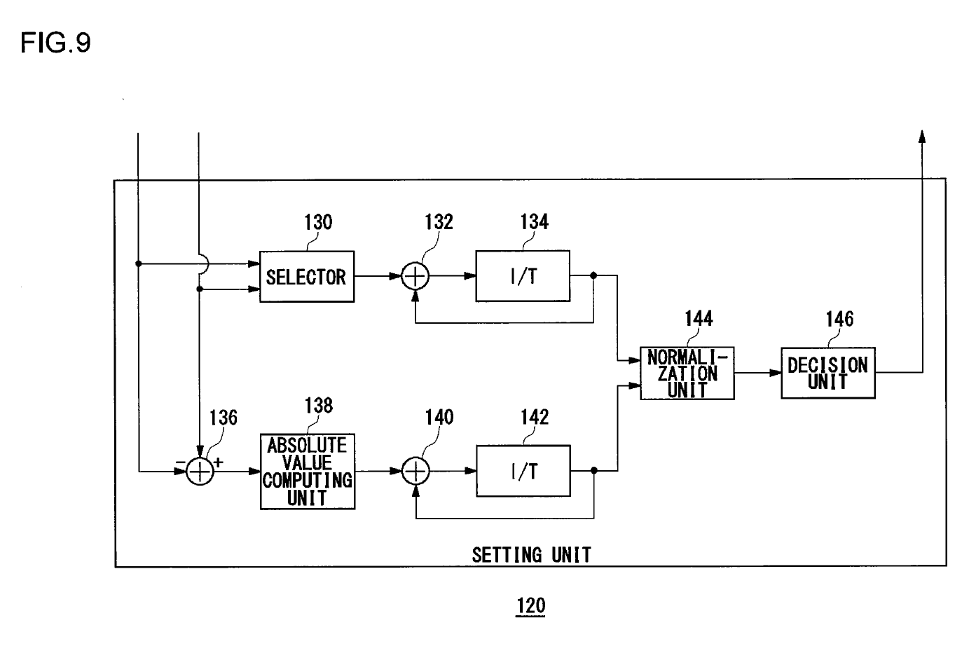

FIG. 9 shows a structure of the setting unit 120. The setting unit 120 includes a selector 130, an adder 132, an adjuster 134, an adder 136, an absolute-value computing unit 138, an adder 140, an adjuster 142, a normalization unit 144, and a decision unit 146.

The selector 130 receives an amplitude component of a symbol and an amplitude component of an immediately preceding symbol for each subcarrier and selects the larger of the two. The adder 132 and the adjuster 134 accumulate the amplitude components selected by the selector 130 for a plurality of subcarriers within each symbol. The adder 136 derives a difference between amplitude components by subtracting the amplitude component of an immediately preceding symbol from that of a present symbol for each subcarrier. The absolute-value computing unit 138 computes the absolute value of the difference derived by the adder 136. The adder 140 and the adjuster 142 accumulate the absolute values of differences computed by the absolute-value computing unit 138 for a plurality of subcarriers within each symbol.

The normalization unit 144 receives the input of an accumulated value of selected values from the adjuster 134 and also receives the input of an accumulated value of the absolute values of differences from the adjuster 142. The normalization unit 144 normalizes the accumulated value of the absolute values of differences by dividing it by the accumulated value of selected values. The decision unit 146 decides a threshold value based on the value normalized by the normalization unit 144. For example, the decision unit 146 may store a table associating normalized values with threshold values in advance and determines a threshold value from a normalized value by referencing the table. Note that the table is so defined that the larger the normalized value is, the larger the threshold value is. The decision unit 146 outputs the thus determined threshold value.

Next a description will be given of another modification of the exemplary embodiment of the present invention. In the exemplary embodiment, the portion of frame synchronization code in a TPS frame is substituted with a frame synchronization code which is stored in advance. In this another modification, the portion of frame number in a TPS frame is also substituted with a frame number which is stored in advance. The receiving apparatus 100 according to this another modification is of the same type as one shown in FIG. 1. Also, as shown in FIG. 3B, the TPS frame contains known data as a frame number to be used for the identification of the frame. Here, in the case of DVB-T, four frames constitute a super-frame, and thus frame numbers “0” to “3” are repeated.

The substitution unit 84 as shown in FIG. 5, following an instruction from the control unit 18 of FIG. 1, specifies a portion of a TPS frame where a frame number is to be placed. The control unit 18 receives a frame number from the storage 82 and substitutes the frame number for the data in the specified portion. That is, once a frame number is specified by the control unit 18, the substitution unit 84, from this point on, substitutes previously stored values of not only the frame synchronization code but also the frame number for the decision results of the decision unit 54. The operations of the syndrome computation unit 86, the error detector 88, and the error corrector 90 are the same as in the exemplary embodiment.

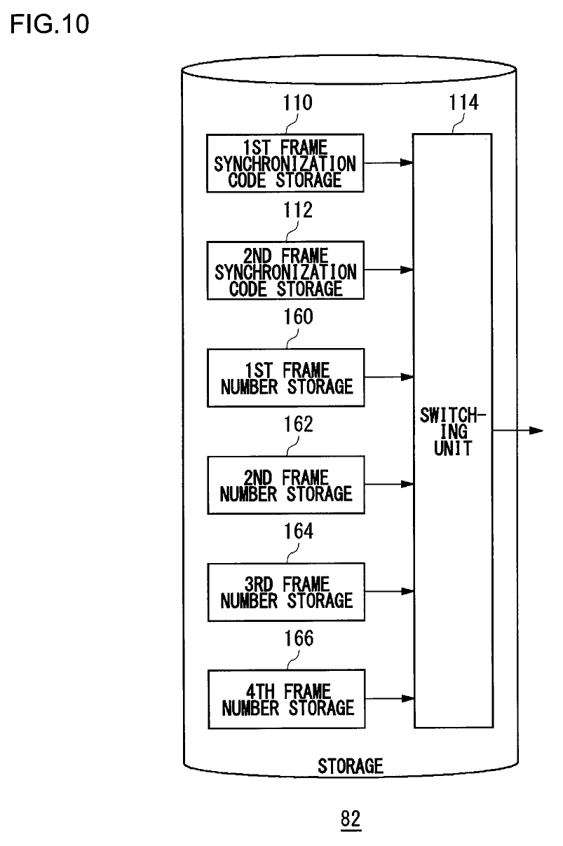

FIG. 10 shows a structure of the storage 82 according to another modification of the exemplary embodiment of the present invention. The storage 82 includes a first frame synchronization code storage 110, a second frame synchronization code storage 112, a first frame number storage 160, a second frame number storage 162, a third frame number storage 164, a fourth frame number storage 166, and a switching unit 114.

The first frame synchronization code storage 110 and the second frame synchronization code storage 112 are the same as those in FIG. 7, and thus the description thereof is omitted here. The first frame number storage 160 through the fourth frame number storage 166 store frame numbers “0” through “3” respectively. The switching unit 114 selects an even code from the first frame synchronization code storage 110 or an odd code from the second frame synchronization code storage 112 for the portion of frame synchronization code in a TPS frame and outputs it. The switching unit 114 selects one of frame number “0” from the first frame number storage 160, frame number “1” from the second frame number storage 162, frame number “2” from the third frame number storage 164, and frame number “3” from the fourth frame number storage 166, and outputs it.

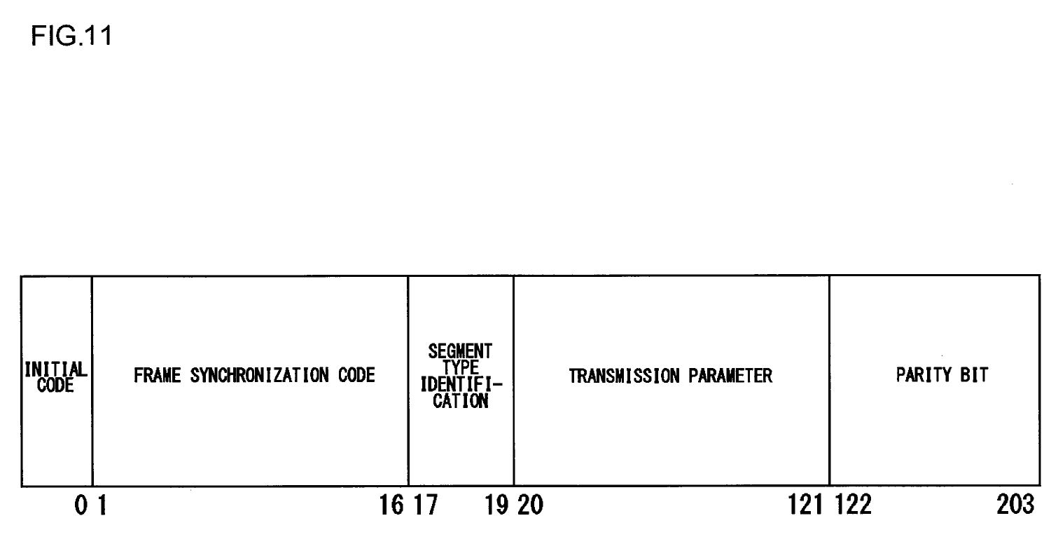

Next a description will be given of still another modification of the exemplary embodiment of the present invention. In the exemplary embodiment, processes concerning TPS have been described in relation to DVB-T. In this still another modification, processes concerning TMCC will be described in relation to ISDB-T. Similarly to TPS, TMCC is assigned to some of the plurality of subcarriers. FIG. 11 shows a frame format of TMCC according to still another modification of the exemplary embodiment. A TMCC code is comprised of 204 symbols, namely, “0” to “203”. The “initial code” and the “frame synchronization code” are specified the same way as TPS. The “segment type identification code” is a code for identifying whether the segment is differentially modulated or synchronously modulated. The “transmission parameter” is where information, such as modulation scheme, coding rate, and the like, is mapped. The “parity bit” is comprised of the codes for error detection and correction of symbols 0 to 121 by BCH decoding.

The receiving apparatus 100, the control signal processor 36, and the storage 82 according to this still another modification are of the same type as those of FIG. 1, FIG. 5, and FIG. 7. Hence, the description thereof is omitted here.

According to the exemplary embodiment of the present invention, in performing a differential detection, phase differences are derived from phase components while the weighting is done by amplitude components. Thus, it is possible to improve the receiving characteristics while suppressing the increase in circuit size of a receiving apparatus. Also, because of the derivation of phase differences from phase components, it is possible to avoid complex multiplication and suppress the increase in circuit size of a receiving apparatus. Also, because of the weighting by amplitude components, the receiving characteristics can be improved with the reliability of received symbols reflected in the decision. Moreover, since a weighting factor is generated based on the smaller of the amplitude components of two symbols, it is possible to reflect the received power for the symbols in the weighting factor.

Since “0” is set as the value of weighting factor when the smaller of the amplitude components of two symbols is smaller than the threshold value, the effects of noise can be reduced. Further, since the threshold value is variably set, the threshold value can be adjusted to the channel variation. The transmission parameters can be decoded with high accuracy by a relatively simple circuitry. And the decoding can be highly accurate in an fading environment where the received power of subcarriers changes dynamically between symbols or within a single symbol.

Furthermore, since the syndrome computation is performed after the portions of a data frame where known data are placed are substituted with known data, it is possible to improve the receiving characteristics while suppressing the increase in circuit size of a receiving apparatus. The substitution of the portions where known data are to be placed with known data realizes a highly accurate decoding by relatively simple circuitry. The substitution with known data results in an improvement of receiving characteristics even when there are limits to the numbers of error detections and error corrections. Since errors that have occurred in known data can be ignored, the errors at the BCH decoder can be reduced from the probability point of view.

The description of the invention given above is based upon illustrative embodiments. These exemplary embodiments are intended to be illustrative only and it will be obvious to those skilled in the art that various other modifications to constituting elements and processes could be developed and that such modifications are also within the scope of the present invention.

In the exemplary embodiment, the weighting factor derivation unit 68 selects the smaller of the amplitude components of two symbols and generates a weighting factor based on the selected amplitude component. However, the application of the exemplary embodiment of the present invention is not limited to such a selection, and a weighting factor may be generated based on an average value of the amplitude components of two symbols, for instance. And the weighting factor derivation unit 68 may compute an average value for the amplitude components for each subcarrier. The weighting factor derivation unit 68 may also generate a weighting factor for phase differences, based on the computed average value. Note here that the weighting factor derivation unit 68 may use the computed average value directly as the weighting factor. Further, the weighting factor derivation unit 68 may also generate a weighting factor with the value of “0” that can nullify the phase difference when the computed average value is smaller than the threshold value. According to this modification, the weighting factor is generated based on the average value, so that the effects of noise can be reduced. Since a weighting factor with the value of “0” is generated when the average value is smaller than the threshold value, the effects of noise can be reduced.

While the exemplary embodiments of the present invention and their modifications have been described using specific terms, such description is for illustrative purposes only, and it is to be understood that changes and variations may still be further made without departing from the spirit or scope of the appended claims.

What is claimed is:

1. A decoding apparatus, comprising:
an input unit which inputs a block-coded data frame;
a substitution unit which specifies an area, where known data are to be assigned, among the data frame inputted in said input unit and which substitutes data in the specified area with the known data;
a computing unit which performs syndrome computation on the data frame substituted by said substitution unit; and
a detector which detects an error in the data frame, based on a result of syndrome computation performed by said computing unit.

2. A decoding apparatus according to claim 1, wherein a frame synchronization codestream is contained in the data frame inputted in said input unit, and
wherein said substitution unit acquires the frame synchronization codestream in advance, specifies an area, where the frame synchronization codestream is to be assigned, among the data frame inputted in said input unit, and substitutes data in the specified area with the frame synchronization codestream.

3. A decoding apparatus according to claim 1, wherein a frame number is contained in the data frame inputted in said input unit, and
wherein said substitution unit acquires the frame number in advance, specifies an area, where the frame synchronization codestream is to be assigned, among the data frames inputted in said input unit, and substitutes data in the specified area with the frame number.

4. A receiving apparatus, comprising:
a receiver which receives a multicarrier signal where control signals are assigned to at least two subcarriers and data signals are assigned to the remaining subcarriers;
a separator which separates the multicarrier signal received by said receiver into the control signals and the data signals;
a first demodulator which demodulates the control signals separated by said separator; and
a second demodulator which demodulates the data signals separated by said separator,
said first demodulator including:
a substitution unit which specifies an area, where known data are to be assigned, among a block-coded data frame and which substitutes data in the specified area with the known data, the data frame being data frame of the control signals separated by said separator;
a computing unit which performs syndrome computation on the data frame substituted by the substitution unit; and
a detector which detects an error in the data frame, based on a result of syndrome computation performed by the computing unit.

5. A decoding method, comprising:
inputting a block-coded data frame;
specifying an area, where known data are to be assigned, among the inputted data frame and substituting data in the specified area with the known data;
performing syndrome computation on the substituted data frame; and
detecting an error in the data frame, based on a result of syndrome computation.

6. A computer readable medium encoded with a computer program product for performing the steps of:
inputting a block-coded data frame;
specifying an area, where known data are to be assigned, among the inputted data frame and substituting data in the specified area with the known data;
performing syndrome computation on the substituted data frame; and
detecting an error in the data frame, based on a result of syndrome computation.
